(19) United States
(12) Patent Application Publication
(10) Pub. No.: US 2023/0213242 A1
(43) Pub. Date: Jul. 6, 2023

(54) WATER TANK HEATING METHOD AND UNIT, ELECTRONIC DEVICE AND SOFC SYSTEM

(71) Applicant: Ceres Intellectual Property Company Limited, Horsham, West Sussex (GB)

(72) Inventor: Cuiling Song, Weifang, Shandong (CN)

(21) Appl. No.: 18/009,564

(22) PCT Filed: Jun. 29, 2021
(86) PCT No.: PCT/CN2021/103103

§ 371 Date: Dec. 9, 2022

(30) Foreign Application Priority Data
Jun. 30, 2020 (CN) 202010622355.X

(51) Int. Cl. F24H 15/429; F24H 15/296; F24H 15/136; H01M 8/0612; H01M 8/04119; H01M 8/04223; H01M 8/04701; H01M 8/0432; H01M 8/04537; H01M 8/12; H01M 8/04225; H01M 8/04302

(52) U.S. Cl. CPC F24H 15/429; F24H 15/136; F24H 15/296; H01M 8/12; H01M 8/0618; H01M 8/04156; H01M 8/04225; H01M 8/04253; H01M 8/04302; H01M 8/04365; H01M 8/04626; H01M 8/04731; H01M 2008/1293; H01M 2250/20

(57) ABSTRACT

The invention provides a water tank heating method and unit, an electronic device and a solid oxide fuel cell (SOFC) system. Before the SOFC system is started, ice in a water tank has been heated up, so after the SOFC system is started, the heating time of the heated ice, i.e., the thawing time of the water tank, will be shortened. Further, in the ice heating process, a pre-set needed SOFC thawing time determined according to current stack outlet temperature is used as a heating control parameter. As the stack outlet temperature is a key factor influencing the starting time of the SOFC system, the heating control will be more accurate if the pre-set needed SOFC thawing time corresponding to the stack outlet temperature is used as a heating control parameter.

### TECHNICAL FIELD

The present invention relates to the water tank heating field, particularly to a water tank heating method and unit, an electronic device, and a solid oxide fuel cell (SOFC) system.

### BACKGROUND ART

The start and operation of an SOFC system need to use deionized water. The deionized water in a water tank enters a reformer or stack in the SOFC system and goes through a reforming reaction (e.g., CH₄+H₂O═CO₂+H₂) to provide the stack with hydrogen, which can be used in reactions and generate power. Inside the stack, a reaction of H₂+O₂═H₂O will also occur and the generated water will return to the water tank through condensation and recovery.

After the SOFC system on a vehicle stops running, the water in the water tank will be gradually frozen when the ambient temperature is below 0° C. When the SOFC system is started again, the deionized water in the water tank is in a frozen state and needs to be heated by a water tank thawing system into a liquid state before being supplied to the SOFC system, thereby ensuring a successful start of the SOFC system

When the ice in the water tank is at low temperature, it takes a longer time to heat the ice in the water tank into water, resulting in a longer starting time of the SOFC system.

### SUMMARY OF THE INVENTION

The present invention provides a water tank heating method and unit, an electronic device, and an SOFC system to address the problem that when the ice in the water tank is at low temperature, it takes a longer time to heat the ice in the water tank into water, resulting in a longer starting time of the SOFC system.

A water tank heating method is provided. The method is used in a water tank thawing controller in a water tank thawing system and comprises steps of:
obtaining the current temperature of a target object in a water tank in the case that SOFC system power-off information is received, wherein the SOFC system power-off information is generated by a vehicle control unit based on a received instruction of the pre-set sleep mode triggered by the user;
calculating the actual thawing time needed for heating the target object in the water tank from the current temperature to pre-set temperature according to water tank parameter information in the case that the current temperature is lower than a pre-set temperature threshold; and
starting a heater in the water tank thawing system to heat the target object in the water tank until a pre-set heating stop condition is met in the case that the actual thawing time is greater than a pre-set needed SOFC thawing time, wherein the pre-set needed SOFC thawing time is determined according to current stack outlet temperature.

Optionally, in the process of starting the heater in the water tank thawing system to heat the target object in the water tank, the method further comprises steps of:
obtaining remaining battery power; and
controlling the water tank thawing system to be powered off in the case that the remaining battery power is lower than a pre-set threshold.

Optionally, the step of starting a heater in the water tank thawing system to heat the target object in the water tank until a pre-set heating stop condition is met comprises steps of:
starting the heater in the water tank thawing system to heat the target object in the water tank;
obtaining the actual thawing time in real time; and
stopping heating the water tank in the case that the difference between the pre-set needed SOFC thawing time and the actual thawing time meets a pre-set difference condition, or the temperature of the target object in the water tank is greater than a pre-set temperature threshold.

Optionally, the process of determining the pre-set needed SOFC thawing time comprises steps of:
obtaining a correspondence between pre-set stack outlet temperature and a reference thawing time; and
searching in the correspondence and obtaining a reference thawing time corresponding to the current stack outlet temperature.

Optionally, the step of calculating the actual thawing time needed for heating the target object in the water tank from the current temperature to the pre-set temperature according to water tank parameter information comprises steps of:
calculating the energy needed for heating the target object in the water tank from the current temperature to the pre-set temperature;
obtaining the heating power of a heater in the water tank thawing system and the heat dissipating power of the water tank;
calculating a difference between the heating power and the heat dissipating power; and
determining the ratio of the energy to the difference as the actual thawing time needed for heating the target object in the water tank from the current temperature to the pre-set temperature.

A water tank heating unit is provided. The unit is used in a water tank thawing controller in a water tank thawing system and comprises:
a temperature obtaining module, used for obtaining the current temperature of a target object in a water tank in the case that SOFC system power-off information is received, wherein the SOFC system power-off information is generated by a vehicle control unit based on a received instruction of the pre-set sleep mode triggered by the user;
a time calculating module, used for calculating the actual thawing time needed for heating the target object in the water tank from the current temperature to pre-set temperature according to water tank parameter information in the case that the current temperature is lower than a pre-set temperature threshold; and
a heating control module, used for starting a heater in the water tank thawing system to heat the target object in the water tank until a pre-set heating stop condition is met in the case that the actual thawing time is greater than a pre-set needed SOFC thawing time, wherein the pre-set needed SOFC thawing time is determined according to current stack outlet temperature.

Optionally, the unit further comprises:

a power-off control module, used for obtaining remaining battery power, and controlling the water tank thawing system to be powered off in the case that the remaining battery power is lower than a pre-set threshold.

Optionally, the heating control module comprises:
a heating starting submodule, used for starting the heater in the water tank thawing system to heat the target object in the water tank;
a time obtaining submodule, used for obtaining the actual thawing time in real time; and
a heating control submodule, used for stopping heating the water tank in the case that the difference between the pre-set needed SOFC thawing time and the actual thawing time meets a pre-set difference condition, or the temperature of the target object in the water tank is greater than a pre-set temperature threshold.

Optionally, the water tank heating unit further comprises a time determining module, which is used for:

obtaining a correspondence between pre-set stack outlet temperature and a reference thawing time, searching in the correspondence and obtaining a reference thawing time corresponding to the current stack outlet temperature.

An electronic device is provided. The electronic device comprises a memory and a processor;
wherein the memory is used for storing programs; and
the processor invokes programs and is used for:
obtaining the current temperature of a target object in a water tank in the case that SOFC system power-off information is received, wherein the SOFC system power-off information is generated by a vehicle control unit based on a received instruction of the pre-set sleep mode triggered by the user;
calculating the actual thawing time needed for heating the target object in the water tank from the current temperature to pre-set temperature according to water tank parameter information in the case that the current temperature is lower than a pre-set temperature threshold; and
starting a heater in the water tank thawing system to heat the target object in the water tank until a pre-set heating stop condition is met in the case that the actual thawing time is greater than a pre-set needed SOFC thawing time, wherein the pre-set needed SOFC thawing time is determined according to current stack outlet temperature.

An SOFC system is provided. The SOFC system comprises the foregoing electronic device.

Compared with the prior art, the present invention has the following beneficial effects:

The present invention provides a water tank heating method and unit, an electronic device, and an SOFC system. Before SOFC system power-off information is received, i.e., the SOFC system is started, if the current temperature is lower than a pre-set temperature threshold, and the actual thawing time is greater than a pre-set needed SOFC thawing time, the heater in the water tank thawing system will be started to heat the target object in the water tank until a pre-set heating stop condition is met. In other words, before the SOFC system is started, the ice in the water tank has been heated up, so after the SOFC system is started, the heating time of the heated ice, i.e., the thawing time of the water tank, will be shortened. Further, in the ice heating process, a pre-set needed SOFC thawing time determined according to the current stack outlet temperature is used as a heating control parameter. As the stack outlet temperature is a key factor influencing the starting time of the SOFC system, the heating control will be more accurate if the pre-set needed SOFC thawing time corresponding to the stack outlet temperature is used as a heating control parameter.

### BRIEF DESCRIPTION OF THE DRAWINGS

The drawings used in the description are briefly described below. These are just some embodiments of the present invention.

FIG. 1 is a structural schematic view of a water tank thawing system.;

FIG. 2 is a method flow chart of a water tank heating method.

FIG. 3 is a method flow chart of another water tank heating.

FIG. 4 is a method flow chart of a further water tank heating method.

FIG. 5 is a structural schematic view of a water tank heating unit.

### DETAILED DESCRIPTION

Embodiments of the present invention are described below in conjunction with the drawings. The described embodiments are only some embodiments of the present invention. Other embodiments within the scope of the claims are also possible.

During the operation of the SOFC system, as water is continuously recovered through condensation, even in the case of low ambient temperature, the problem of icing will not often occur. However, after the SOFC system stops running and when the external ambient temperature is lower than 0° C., the water in the water tank will gradually freeze, causing failure of water supply.

When the SOFC system is started again, the deionized water in the water tank is in a frozen state and needs to be heated by a water tank thawing system into a liquid state during start of the SOFC system before being supplied to the SOFC system, so that the SOFC system gradually enters a power generation state and is successfully started. However, when the ice in the water tank is at low temperature, it takes a longer time to heat the ice in the water tank into water. If thawing is not successful, the necessary water supply to the SOFC system will fail, causing the problem of a prolonged starting time of the SOFC system.

The invention recognizes that if the ice in the water tank can still be heated after the SOFC system is powered off, then when the SOFC system is started, as the ice has been preheated, less time and energy will be needed to heat the ice, thereby shortening the starting time of the SOFC.

In order to achieve the foregoing technical effect, two operating modes are pre-set. One is a pre-set sleep mode, and the other is a shutdown mode. The actual mode is manually selected. When the vehicle stops, the user, such as the driver, can select a stop mode according to the estimated downtime. For example, when the downtime is short at low temperature, the pre-set sleep mode is selected, and when the temperature is high or the downtime is long, the shutdown mode is selected.

When the shutdown mode is selected, all devices such as the water tank thawing system and the SOFC system are powered off and stop working. When the shutdown mode is selected, the vehicle control unit receives an instruction of the shutdown mode selected by the user and controls the water tank thawing system, the SOFC system, and other devices to be powered off.

When the pre-set sleep mode is selected, the SOFC system is powered off, but the water tank thawing controller in the water tank thawing system, the stack outlet temperature sensor, and the temperature sensor in the water tank still work. The water tank thawing controller determines, according to the temperature sensor in the water tank and the stack outlet temperature sensor, whether to start the heater to heat the water tank. When the pre-set sleep mode is selected, the vehicle control unit receives an instruction of the pre-set sleep mode selected by the user and controls the SOFC system and other devices to be powered off, but the water tank thawing controller in the water tank thawing system, the stack outlet temperature sensor, and the temperature sensor in the water tank are still powered on and operate. Further, after controlling the SOFC system and other devices to be powered off, the vehicle control unit will transfer SOFC system power-off information to the water tank thawing controller in the water tank thawing system to trigger the water tank thawing controller to perform water tank heating operation after SOFC power-off.

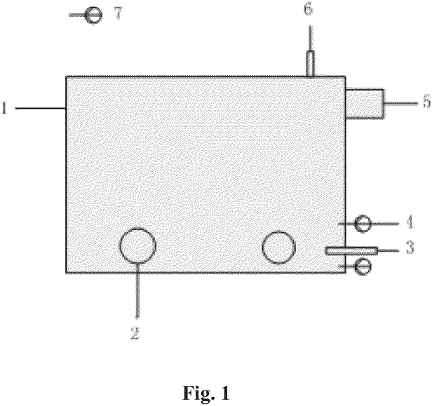

The section above describes the underlying concept of the invention. The structure of the water tank thawing system provided by the present invention is shown in FIG. 1. The thawing system comprises a water tank 1, a heater 2, a temperature sensor 4 in the water tank, an ambient temperature sensor 7, a stack outlet temperature sensor, a water tank thawing controller 5, and heat-insulating wool. The water tank 1 is a water storage vessel and comprises a water inlet (water tank inlet 6) connected to a water recovery device and allowing recovered water to enter the water tank, and a water outlet (water tank outlet 3) connected to a downstream water pump and other water conveyors and allowing the water in the water tank 1 to be conveyed to components in need. The heater 2 is mounted inside the water tank and used for heating or thawing. The temperature sensor 4 in the water tank is used for measuring the temperature of the water or ice in the water tank 1. The ambient temperature sensor 7 is used for measuring ambient temperature. The stack outlet temperature sensor is used for measuring stack outlet temperature and predicting the time from start of the SOFC system to water supply. The water tank thawing controller 5 is used for collecting signals and issuing instructions to the heater 2. The heat-insulating wool wraps the outside of the water tank to reduce outward heat dissipation of the water tank.

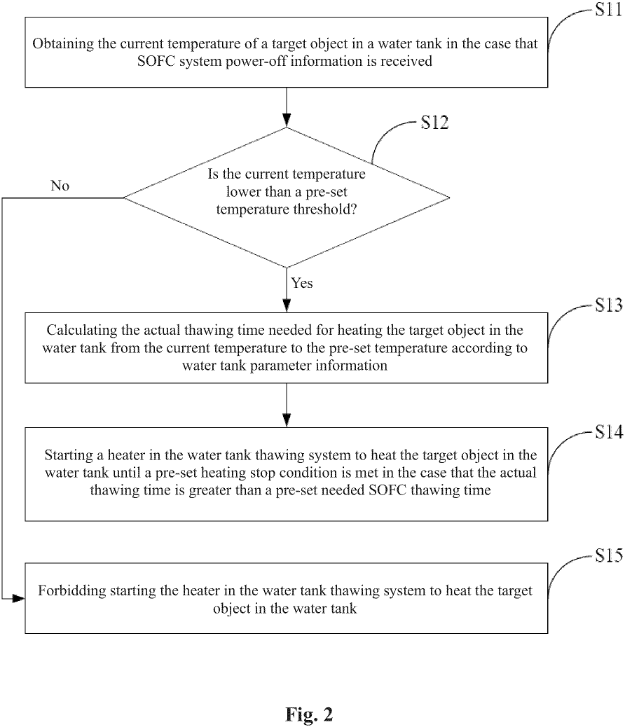

An embodiment of the present invention provides a water tank heating method, which is used in a water tank thawing controller in a water tank thawing system, as shown in FIG. 2, and comprises steps of:

S11: obtaining the current temperature of a target object in a water tank in the case that SOFC system power-off information is received.

The process of generating SOFC system power-off information is disclosed above.

In this embodiment, after the vehicle stops, if the user selects a pre-set sleep mode, the vehicle control unit will transfer SOFC system power-off information to the water tank thawing controller in the water tank thawing system after controlling the SOFC system and other devices to be powered off. That is, the SOFC system power-off information is generated by the vehicle control unit based on a received instruction of the pre-set sleep mode triggered by the user.

When the vehicle stops, the ambient environment directly determines whether the water in the water tank will be frozen. If the ambient temperature is below 0° C., the water in the water tank will be frozen, but if the ambient temperature is above 0℃, the water in the water tank will not be frozen. As it is unknown in advance whether the object in the water tank is water or ice, the object is generally referred to as a target object. The target object may be water, or ice.

When the current temperature of the target object is needed, the temperature sensor 4 in the water tank is used. The temperature sensor will detect and obtain the temperature of the target object.

S12: determining whether the current temperature is lower than a pre-set temperature threshold; if yes, then go to S13; if not, then go to S15.

When the temperature is above 0° C., the water will not be frozen. In this case, when the SOFC is started, the water will not be heated. However, when the temperature is below 0° C., the water will be frozen. In this case, when the SOFC is started, the water needs to be heated. Therefore, the pre-set temperature threshold is 0° C. in general.

S13: calculating the actual thawing time needed for heating the target object in the water tank from the current temperature to the pre-set temperature according to water tank parameter information.

In this embodiment, the pre-set temperature can be any temperature above 0° C. and, for example, below 5° C., e.g., any temperature above 3℃ and below 5° C. The energy needed for thawing ice into water is much more than the energy needed for heating water from 0℃ to a specific temperature, so in this embodiment, the pre-set temperature can be set to be any temperature above 0° C. and below 5° C., e.g., any temperature above 3° C. and below 5° C.

The time for heating the target object in the water tank from the current temperature to the pre-set temperature is the actual thawing time needed for thawing ice into water.

S14: starting a heater in the water tank thawing system to heat the target object in the water tank until a pre-set heating stop condition is met in the case that the actual thawing time is greater than a pre-set needed SOFC thawing time.

A pre-set needed SOFC thawing time is set in advance. As stack outlet temperature is a factor influencing the starting time of the SOFC system, and also a factor influencing the time from the start of the system to water supply, the pre-set needed SOFC thawing time in this embodiment is determined according to current stack outlet temperature.

Firstly, time t₁ from start to water supply (i.e., reference thawing time) is tested in advance at various stack outlet temperatures, and a function t₁=g (Tstack outlet) is obtained through data fitting. That is, a correspondence between the stack outlet temperature and the pre-set needed SOFC thawing time is obtained in advance. Then stack outlet temperature sensor is used to detect the current stack outlet temperature, and a reference thawing time corresponding to the stack outlet temperature can be searched in the foregoing correspondence and is used as the pre-set needed SOFC thawing time.

In the case that the actual thawing time is greater than the pre-set needed SOFC thawing time, i.e. the required actual thawing time is greater than the pre-set needed SOFC thawing time, the heater will be started to reduce the needed actual thawing time.

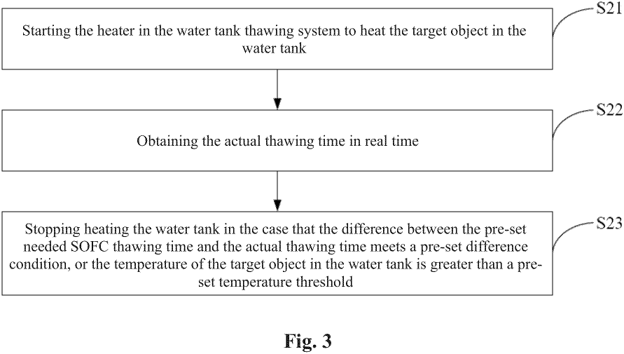

After the heater in the water tank thawing system is started to heat the target object in the water tank, the heating is not continuous, and will be stopped when a pre-set heating stop condition is met, see FIG. 3. S14 may comprise steps of:

S21: starting the heater in the water tank thawing system to heat the target object in the water tank.

S22: obtaining the actual thawing time in real time.

After the heater is used to heat the water tank, the temperature of the target object in the water tank will rise and the actual thawing time needed for heating the target object from the current temperature to the pre-set temperature will be gradually reduced. In this case, the actual thawing time needs to be calculated in real time.

S23: stopping heating the water tank in the case that the difference between the pre-set needed SOFC thawing time and the actual thawing time meets a pre-set difference condition or the temperature of the target object in the water tank is greater than a pre-set temperature threshold.

The method sets two pre-set heating stop conditions in advance. The first pre-set heating stop condition is that the difference between the pre-set needed SOFC thawing time and the actual thawing time meets the pre-set difference condition. For a pre-set needed SOFC thawing time t₁ and an actual thawing time t₂, t₁ and t₂ should meet t₁ ≥t₂+tmin, where t can be 3 min. That is, in this embodiment, when the difference between the pre-set needed SOFC thawing time and the actual thawing time is greater than the pre-set difference, heating is stopped and at this moment the target object in the water tank may still be ice. The present invention can achieve accurate control of temperature and compared with the constant maintenance of an unfrozen state in the water tank, the heating time is shorter and the energy consumption can be saved.

The second pre-set heating stop condition is that the temperature of the target object in the water tank is greater than the pre-set temperature threshold. In actual applications, the pre-set temperature threshold can be 0℃. That is, after the ice in the water tank melts into water, even if the SOFC system is started at this moment, water can be supplied directly without heating.

In the embodiment of the present invention, when any of the pre-set heating stop conditions is met, heating is stopped, which can ensure the shortest heating time.

That is, in the embodiment of the present invention, when current temperature Tₜₐₙₖ is greater than 0° C., heating is not conducted.

When Tₜₐₙₖ is less than or equal to 0° C., thawing time t₂ is calculated. When Tₜₐₙₖ is equal to 0℃, calculation is conducted based on all the ice at 0℃;

If t₁ is less than or equal to t₂, the heater will be started. The heating is stopped when t₁ is greater than or equal to t₂+3 min or Tₜₐₙₖ is greater than 0° C.

In the heating process of the heater, the pre-set sleep mode needs to consume the power from the battery, and power needs to be supplied to electrical elements such as fans when the SOFC system is started. In order to prevent the battery from consuming too much power, causing failure to start the system, the remaining battery power needs to be obtained in real time, and it should be set that when the remaining battery power is less than or equal to Qe, the pre-set sleep mode is switched to a shutdown mode. In this case, the water tank thawing controller controls the water tank thawing system to be powered off. Here, Qe is the electric quantity consumed from the time when the SOFC system is started to the time when the net power is greater than 0 and is a calibrated quantity. After the power of the battery is lower than a threshold, the sleep mode is automatically switched to the shutdown mode and there will not be a risk of start failure of the SOFC system caused by low battery power.

Before SOFC system power-off information is received, i.e. the SOFC system is operating, if the current temperature is lower than the pre-set temperature threshold and the actual thawing time is greater than the pre-set needed SOFC thawing time, the heater in the water tank thawing system will be started to heat the target object in the water tank until a pre -set heating stop condition is met. In other words, before the SOFC system is started, the ice in the water tank has been heated up, so after the SOFC system is started, the heating time of the heated ice, i.e. the thawing time of the water tank, will be shortened. Further, in the ice heating process, a pre-set needed SOFC thawing time determined according to the current stack outlet temperature is used as a heating control parameter. As the stack outlet temperature is a factor influencing the starting time of the SOFC system, the heating control will be more accurate if the pre-set needed SOFC thawing time corresponding to the stack outlet temperature is used as a heating control parameter.

In addition to the foregoing method of starting the heater to heat when the current temperature is lower than the pre-set temperature threshold and the actual thawing time is greater than the pre-set needed SOFC thawing time, and stopping heating when a pre-set heating stop condition is met, continuous electric heating to prevent freezing at low temperature can also be adopted. However, this method will consume more electric energy and has a risk of starting failure due to low battery power. The foregoing method of starting the heater to heat when the current temperature is lower than the pre-set temperature threshold and the actual thawing time is greater than the pre-set needed SOFC thawing time, and stopping heating when a pre-set heating stop condition is met, consumes less electric energy.

Heat-insulating wool or other heat insulating material can be arranged outside the water tank to retain heat. Through the heat-insulating wool and the heater, which works intermittently, power consumption is reduced as much as possible while the water supply requirement is met.

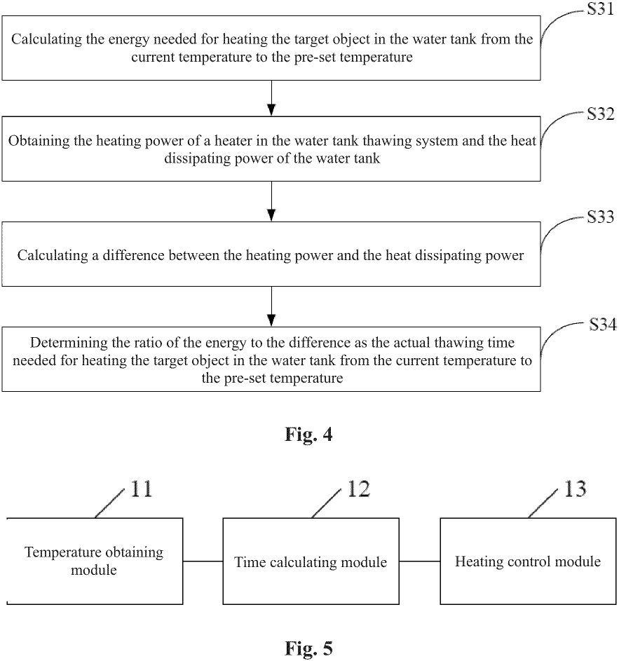

The above embodiment involves calculating the actual thawing time needed for heating the target object in the water tank from the current temperature to the pre-set temperature according to water tank parameter information. A specific implementation process is shown in FIG. 4 Step S12 may comprise steps of:

S31: calculating the energy needed for heating the target object in the water tank from the current temperature to the pre-set temperature.

S32: obtaining the heating power of a heater in the water tank thawing system and the heat dissipating power of the water tank.

S33: calculating a difference between the heating power and the heat dissipating power.

S34: determining the ratio of the energy to the difference as the actual thawing time needed for heating the target object in the water tank from the current temperature to the pre-set temperature.

The actual thawing time t₂ can be calculated by the following method: t₂=Q/(Pₕₑₐₜₑᵣ-Pₗₒₛₛ)

The volume of the water in the water tank can be calculated by multiplying the cross-sectional area inside the water tank by the liquid level. The liquid level is the liquid level after stopping to avoid inaccuracy in the liquid level caused by icing. Then, according to the latent heat of the phase change when the ice melts into water, the time t₂ needed for heating the water or ice in the water tank from the current temperature to 5° C. is calculated.

Where Q is the energy needed for melting all the ice in the water tank,

$$\text{Q} = \text{cm} \left(5 {\text{-T}}_{\text{tank}}\right) + \text{m} * \text{L}$$

where,
c is the specific heat capacity of ice, and its value is 2100 J/(kg°C),
Tₜₐₙₖ is real-time temperature in the water tank, i.e., the current temperature as described above;
m is the mass of the water or ice in the water tank, m=ρAH, where ρ is the density of water, A is the basal area inside the water tank, and H is the liquid level displayed by the liquid level indicator after stop;
L is the heat of phase change when ice melts into water and its value is 3.305 × 10⁵ J/kg;
Pₕₑₐₜₑᵣ is the power of the heater;
Pₗₒₛₛ is the heat dissipating power of the water tank, Pₗₒₛₛ=k(Tₜₐₙₖ-T_{amb}), where, k is the heat dispersion coefficient of the heat-insulating wool of the water tank (as the interfaces on the water tank have a great bearing on the calculation of heat dissipation, this coefficient is calibrated through testing);
T_{amb} is external ambient temperature and is obtained according to an ambient temperature sensor.

Through steps S31 to S34, the actual thawing time needed for heating the target object in the water tank from the current temperature to the pre-set temperature can be calculated, thereby controlling the heating time of the heater based on the actual thawing time and ensuring the heating accuracy of the target object.

Another embodiment of the present invention provides a water tank heating unit, used in a water tank thawing controller in a water tank thawing system, as shown in FIG. 5. The unit comprises:
a temperature obtaining module 11, used for obtaining the current temperature of a target object in a water tank in the case that SOFC system power-off information is received, wherein the SOFC system power-off information is generated by a vehicle control unit based on a received instruction of the pre-set sleep mode triggered by the user;
a time calculating module 12, used for calculating the actual thawing time needed for heating the target object in the water tank from the current temperature to pre-set temperature according to water tank parameter information in the case that the current temperature is lower than a pre-set temperature threshold; and
a heating control module 13, used for starting a heater in the water tank thawing system to heat the target object in the water tank until a pre-set heating stop condition is met in the case that the actual thawing time is greater than a pre-set needed SOFC thawing time, wherein the pre-set needed SOFC thawing time is determined according to current stack outlet temperature.

Further, the unit also comprises a power-off control module, used for obtaining remaining battery power, and controlling the water tank thawing system to be powered off in the case that the remaining battery power is lower than a pre-set threshold.

Further, the heating control module comprises:
a heating starting submodule, used for starting the heater in the water tank thawing system to heat the target object in the water tank;
a time obtaining submodule, used for obtaining the actual thawing time in real time; and
a heating control submodule, used for stopping heating the water tank in the case that the difference between the pre-set needed SOFC thawing time and the actual thawing time meets a pre-set difference condition, or the temperature of the target object in the water tank is greater than a pre-set temperature threshold.

Further, the unit also comprises a time determining module, which is used for obtaining a correspondence between pre-set stack outlet temperature and a reference thawing time, searching in the correspondence and obtaining a reference thawing time corresponding to the current stack outlet temperature.

Further, the time calculating module is specifically used in:
an energy obtaining submodule, used for calculating the energy needed for heating the target object in the water tank from the current temperature to the pre-set temperature;
a power obtaining submodule, used for obtaining the heating power of a heater in the water tank thawing system and the heat dissipating power of the water tank;
a difference calculating submodule, used for calculating a difference between the heating power and the heat dissipating power; and
a time determining submodule, used for determining the ratio of the energy to the difference as the actual thawing time needed for heating the target object in the water tank from the current temperature to the pre-set temperature.

In this embodiment, before SOFC system power-off information is received, i.e. the SOFC system is operating, if the current temperature is lower than the pre-set temperature threshold and the actual thawing time is greater than the pre-set needed SOFC thawing time, the heater in the water tank thawing system will be started to heat the target object in the water tank until the pre-set heating stop condition is met. In other words, before the SOFC system is started, the ice in the water tank has been heated up, so after the SOFC system is started, the heating time of the heated ice, i.e. the thawing time of the water tank, will be shortened. Further, in the ice heating process, a pre-set needed SOFC thawing time determined according to the current stack outlet temperature is used as a heating control parameter. As the stack outlet temperature is a key factor influencing the starting time of the SOFC system, the heating control will be more accurate if the pre-set needed SOFC thawing time corresponding to the stack outlet temperature is used as a heating control parameter.

The working processes of the modules and submodules in this embodiment can refer to the corresponding description in the above embodiments and will not be described again.

Another embodiment of the present invention provides an electronic device which can be the water tank thawing controller, comprising a memory and a processor. The memory is used for storing programs The processor executes programs and is used for:
obtaining the current temperature of a target object in a water tank in the case that SOFC system power-off information is received, wherein the SOFC system power-off information is generated by a vehicle control unit based on a received instruction of the pre-set sleep mode triggered by the user;
calculating the actual thawing time needed for heating the target object in the water tank from the current temperature to pre-set temperature according to water tank parameter information in the case that the current temperature is lower than a pre-set temperature threshold; and
starting a heater in the water tank thawing system to heat the target object in the water tank until a pre-set heating stop condition is met in the case that the actual thawing time is greater than a pre-set needed SOFC thawing time, wherein the pre-set needed SOFC thawing time is determined according to current stack outlet temperature.

Further, in the process of starting the heater in the water tank thawing system to heat the target object in the water tank, the method further comprises steps of:
obtaining remaining battery power;
controlling the water tank thawing system to be powered off in the case that the remaining battery power is lower than a pre-set threshold.

Further, the step of starting a heater in the water tank thawing system to heat the target object in the water tank until a pre-set heating stop condition is met comprises steps of:
starting the heater in the water tank thawing system to heat the target object in the water tank;
obtaining the actual thawing time in real time; and
stopping heating the water tank in the case that the difference between the pre-set needed SOFC thawing time and the actual thawing time meets a pre-set difference condition, or the temperature of the target object in the water tank is greater than a pre-set temperature threshold.

Further, the process of determining the pre-set needed SOFC thawing time comprises steps of:
obtaining a correspondence between pre-set stack outlet temperature and a pre-set needed SOFC thawing time; and
searching in the correspondence and obtaining a reference thawing time corresponding to the current stack outlet temperature.

Further, the step of calculating the actual thawing time needed for heating the target object in the water tank from the current temperature to the pre-set temperature according to water tank parameter information comprises steps of:
calculating the energy needed for heating the target object in the water tank from the current temperature to the pre-set temperature;
obtaining the heating power of a heater in the water tank thawing system and the heat dissipating power of the water tank;
calculating a difference between the heating power and the heat dissipating power; and
determining the ratio of the energy to the difference as the actual thawing time needed for heating the target object in the water tank from the current temperature to the pre-set temperature.

In this embodiment, before SOFC system power-off information is received, i.e. the SOFC system is operating, if the current temperature is lower than the pre-set temperature threshold and the actual thawing time is greater than the pre-set needed SOFC thawing time, the heater in the water tank thawing system will be started to heat the target object in the water tank until a pre-set heating stop condition is met. In other words, before the SOFC system is started, the ice in the water tank has been heated up, so after the SOFC system is started, the heating time of the heated ice, i.e. the thawing time of the water tank, will be shortened. Further, in the ice heating process, a pre-set needed SOFC thawing time determined according to the current stack outlet temperature is used as a heating control parameter. As the stack outlet temperature is a factor influencing the starting time of the SOFC system, the heating control will be more accurate if the pre-set needed SOFC thawing time corresponding to the stack outlet temperature is used as a heating control parameter.

Optionally, on the basis of the foregoing embodiments, another embodiment of the present invention provides an SOFC system, and the SOFC system comprises the foregoing electronic device, i.e., the SOFC system comprises a water tank thawing system, i.e. the SOFC system comprises the foregoing water tank thawing controller and other devices in the water tank thawing system.

In this embodiment, before SOFC system power-off information is received, i.e. the SOFC system is started, if the current temperature is lower than the pre-set temperature threshold and the actual thawing time is greater than the pre-set needed SOFC thawing time, the heater in the water tank thawing system will be started to heat the target object in the water tank until a pre-set heating stop condition is met. In other words, before the SOFC system is started, the ice in the water tank has been heated up, so after the SOFC system is started, the heating time of the heated ice, i.e. the thawing time of the water tank, will be shortened. Further, in the ice heating process, a pre-set needed SOFC thawing time determined according to the current stack outlet temperature is used as a heating control parameter. As the stack outlet temperature is a factor influencing the starting time of the SOFC system, the heating control will be more accurate if the pre-set needed SOFC thawing time corresponding to the stack outlet temperature is used as a heating control parameter.

Various modifications to these embodiments will be apparent. The general principle defined herein can be implemented in other embodiments without departing from the scope of the present invention.

1. A water tank heating method, for use in a water tank thawing controller in a water tank thawing system for an SOFC system, the method comprising:
obtaining the current temperature of a target object in a water tank in the case that SOFC system power-off information is received, wherein the SOFC system power-off information is generated by a vehicle control unit based on a received instruction of a pre-set sleep mode triggered by a user;
determining that the current temperature is lower than a pre-set temperature threshold and calculating an actual thawing time needed for heating the target object in the water tank from the current temperature to a pre-set temperature according to water tank parameter information;
determining a pre-set SOFC thawing time according to current stack outlet temperature; and
operating a heater in the water tank thawing system to heat the target object in the water tank for the pre-set SOFC thawing time or until a pre-set heating stop condition is met in the case that the actual thawing time is greater than a pre-set needed SOFC thawing time.

2. The water tank heating method according to claim 1, wherein operating the heater in the water tank thawing system to heat the target object in the water tank, the method further comprises:
obtaining a remaining battery power; and
controlling the water tank thawing system to be powered off in the case that the remaining battery power is lower than a pre-set threshold.

3. The water tank heating method according to claim 1, wherein operating the heater in the water tank thawing system to heat the target object in the water tank until a pre-set heating stop condition is met comprises:
starting the heater in the water tank thawing system to heat the target object in the water tank;
obtaining the actual thawing time in real time; and
stopping heating the water tank in the case that the difference between the pre-set needed SOFC thawing time and the actual thawing time meets a pre-set difference condition, or the temperature of the target object in the water tank is greater than a pre-set temperature threshold.

4. The water tank heating method according to claim 1, wherein determining the pre-set needed SOFC thawing time comprises:
obtaining a correspondence between a pre-set stack outlet temperature and a reference thawing time; and
searching in the correspondence and obtaining a reference thawing time corresponding to the current stack outlet temperature.

5. The water tank heating method according to claim 1, wherein calculating the actual thawing time needed for heating the target object in the water tank from the current temperature to the pre-set temperature according to water tank parameter information comprises:
calculating the energy needed for heating the target object in the water tank from the current temperature to the pre-set temperature;
obtaining the heating power of a heater in the water tank thawing system and the heat dissipating power of the water tank;
calculating a difference between the heating power and the heat dissipating power; and
determining the ratio of the energy to the difference as the actual thawing time needed for heating the target object in the water tank from the current temperature to the pre-set temperature.

6. A water tank heating unit for a water tank thawing controller in a water tank thawing system of an SOFC system, comprising:
a temperature obtaining module for obtaining the current temperature of a target object in a water tank when SOFC system power-off information is received, wherein the SOFC system power-off information is generated by a vehicle control unit based on a received instruction of a pre-set sleep mode triggered by a user;
a time calculating module for calculating an actual thawing time needed for heating the target object in the water tank from the current temperature to a pre-set temperature according to water tank parameter information when the current temperature is lower than a pre-set temperature threshold; and
a heating control module for operating a heater in the water tank thawing system to heat the target object in the water tank until a pre-set heating stop condition is met when the actual thawing time is greater than a pre-set needed SOFC thawing time, wherein the pre-set needed SOFC thawing time is determined according to current stack outlet temperature.

7. The water tank heating unit according to claim 6, further comprising:
a power-off control module for obtaining remaining battery power and controlling the water tank thawing system to be powered off in the case that the remaining battery power is lower than a pre-set threshold.

8. The water tank heating unit according to claim 6, wherein the heating control module comprises:
a heater starting submodule for starting the heater in the water tank thawing system to heat the target object in the water tank;
a time obtaining submodule for obtaining the actual thawing time in real time; and
a heater control submodule for stopping heating of the water tank in the case that the difference between the pre-set needed SOFC thawing time and the actual thawing time meets a pre-set difference condition, or that the temperature of the target object in the water tank is greater than a pre-set temperature threshold.

9. The water tank heating unit according to claim 6, further comprising a time determining module for:
obtaining a correspondence between pre-set stack outlet temperature and reference thawing time, searching in the correspondence, and obtaining a reference thawing time corresponding to the current stack outlet temperature.

10. An electronic device, comprising a memory for storing programs and a processor for executing a program for:
obtaining a current temperature of a target object in a water tank when SOFC system power-off information is received, wherein the SOFC system power-off information is generated by a vehicle control unit based on a received instruction of a pre-set sleep mode triggered by the user;
calculating an actual thawing time needed for heating the target object in the water tank from the current temperature to a pre-set temperature according to water tank parameter information in the case that the current temperature is lower than a pre-set temperature threshold; and
operating a heater in the water tank thawing system to heat the target object in the water tank until a pre-set heating stop condition is met in the case that the actual thawing time is greater than a pre-set needed SOFC thawing time, wherein the pre-set needed SOFC thawing time is determined according to a current stack outlet temperature.

11. An SOFC system, comprising an electronic device according to claim 10.
